(19) United States
(12) Patent Application Publication
(10) Pub. No.: US 2017/0161690 A1
(43) Pub. Date: Jun. 8, 2017

(54) MOBILE CREDENTIALS FOR RESOURCES MANAGEMENT IN COLLABORATIVE APPLICATIONS

(71) Applicant: XceedID Corporation, Golden, CO (US)

(72) Inventors: Rocco Vitali, Forli (IT); Samir Tamer, San Jose, CA (US)

(21) Appl. No.: 15/434,696

(22) Filed: Feb. 16, 2017

Related U.S. Application Data
(63) Continuation of application No. 14/166,736, filed on Jan. 28, 2014, now abandoned.
(60) Provisional application No. 61/757,562, filed on Jan. 28, 2013.

(51) Int. Cl. G06Q 10/10; H04W 12/08; H04W 12/06; H04L 29/06

(52) U.S. Cl. CPC G06Q 10/1095; H04L 63/08; H04W 12/08; H04W 12/06; H04L 63/12

(57) ABSTRACT

One or more servers may receive a meeting request from a computer. The one or more servers may transmit a meeting invitation a participant. The participant may accept or decline the meeting invitation. If the participant accepts the meeting invitation, the one or more servers may transmit a credential to the mobile device of the participant.

### CROSS-REFERENCE TO RELATED APPLICATIONS

The present application claims the benefit of U.S. Provisional Patent Application No. 61/757,562, filed on Jan. 28, 2013, which is hereby incorporated by reference in its entirety.

### BACKGROUND

The present invention generally relates to mobile credentials for resources management. Credentials may be used in various systems and managed in various ways. Some existing systems have various shortcomings relative to certain applications. Accordingly, there remains a need for further contributions in this area of technology.

### SUMMARY

One embodiment of the present invention is a unique resources management system using credentials. Other embodiments include apparatuses, systems, devices, hardware, methods, and combinations for managing resources using credentials. Further embodiments, forms, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views, and wherein:

FIG. 1 is a schematic block diagram of an exemplary system; and

FIG. 2 is a schematic block diagram of a computing device.

### DETAILED DESCRIPTION OF EXEMPLARY EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present application is generally directed to management of resources (e.g., conference rooms and/or other equipment which can be accessed and/or controlled by a credential) by delivering a credential to a mobile device, such as a mobile phone, of an invited attendee.

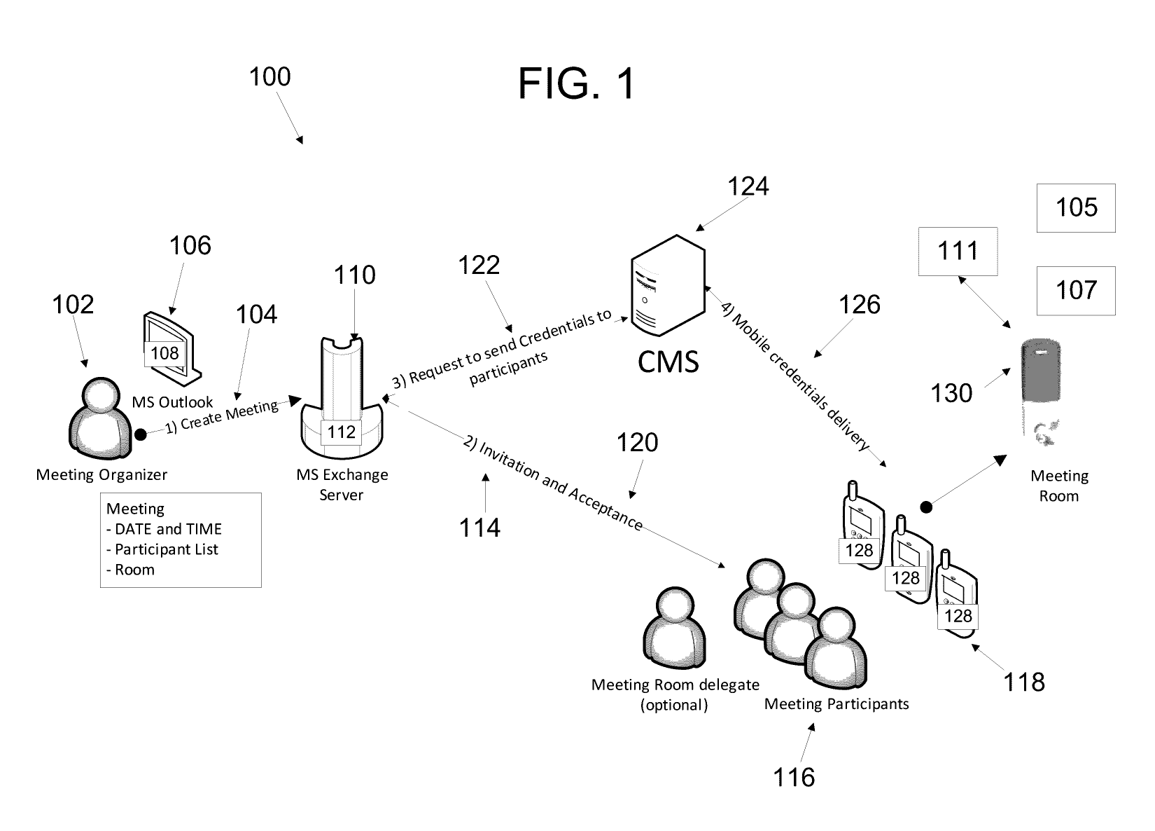

FIG. 1 is a schematic block diagram of an exemplary system 100, which illustrates a process for delivering credentials to a mobile device. Operations illustrated for all of the processes in the present application are understood to be examples only, and operations may be combined or divided, and added or removed, as well as re-ordered in whole or in part, unless explicitly stated to the contrary.

The system 100 includes a meeting organizer 102 that organizes a meeting and generates a meeting request 104 using a computer 106. The computer 106 is a computing device such as a desktop computer, laptop computer, tablet computer, or a mobile phone. The meeting request 104 may include information such as date, time, participant list, room or location 105, and/or equipment 107. The computer 106 includes an email and/or calendaring program 108 such as Microsoft Outlook or Exchange, Lotus Notes, etc. It is contemplated that the calendaring program 108 may not be located on a local machine such as computer 106, but may be part of a cloud service that the computer 106 may access on the Internet.

The system 100 may also include an email and/or calendar server 110. The email and/or calendar server 110 may include an email and/or calendar program 112, which may receive the meeting request 104. The email and/or calendar server 110 may be configured to manage the scheduling, reservation, and availability of rooms 105 and/or equipment 107 in a facility. Rooms 105 and equipment 107 are sometimes referred to as resources. The rooms 105 may be secured by an electronic access control system 111.

The email and/or calendar server 110 may maintain a calendar, may be viewed like an individual's calendar, for the rooms 105 and/or equipment 107. Rooms 105 and/or equipment 107 may be configured to accept reservation requests in multiple ways such as moderated and auto-accept. In a moderated configuration, requests to reserve the resource are generally approved or denied by a person (delegate). Typically, the delegate for a moderated resource will receive an email when someone requests to use that resource. For example, when someone creates a meeting request 104 to reserve a room 105 and/or equipment 107, the delegate will receive an email from the email and/or calendar server 110 that the delegate may accept or deny on behalf of the room 105 and/or equipment 107. Generally, once the delegate accepts the meeting request 104, credential(s) may be delivered to participants who have accepted to the meeting invitation. In an auto-accept configuration, requests to reserve the resource are generally automatically accepted subject to availability. When a request for a room 105 and/or a piece of equipment 107 is accepted in the email and/or calendar server 110, an event may be added to the resource's calendar.

The email and/or calendar server 110 may generate and send a meeting invitation 114 to one or more participants 116. The meeting invitation 114 may be sent to a mobile device 118, e.g., a mobile phone, of each of the participants 116. The participants 116 may transmit acceptances 120 using the mobile device 118. The mobile device 118 may also include an email and/or calendar program (not shown for clarity) that receives the invitation 114 and generates the acceptance 120. It is contemplated that the computer 106 may send the meeting invitation to the participants 116, rather than the email and/or calendar server 110.

After receiving an acceptance 120, the email and/or calendar server 110 may then send a credential request 122 to a credential server 124. The credential server 124 may be a Credential Management Service or Server (CMS). The credential request 122 may include information such as an identification of the room 105 that a participant 116 will be accessing, a facility code, a badge identifier, a date, a time, equipment (e.g., laptops or projectors) 107 in the room to be used, and/or an identification of the participant 116 such as his or her name and/or mobile phone number. In some embodiments, the email and/or calendar server 110 and the credential server 124 may be one server that performs some or all of the functions of both servers.

The credential server 124 may generate one or more credentials 126 and transmit the credential(s) 126 to the mobile device 118 of the participant 118. The credential 126 may be any type of credential such as a MIFARE-type credential. Moreover, other types of credentials are contemplated. In addition, the credential 126 may include a badge identifier, a facility code, and/or one or more keys, among other information that may be included. In some embodiments, the credential 126 may be include information that only allows access to the room for the duration of the meeting. In addition, in some embodiments the access control system 111 may only allow the credential 126 to access the room 105 for the duration of the meeting. It is contemplated that in the various embodiments, the credential 126 and/or access control system 111 may allow participants into the room 105 several minutes (e.g., 15 minutes) before the start of the meeting. The credential 126 may be transmitted to the mobile device 118 using, e.g., an Internet connection, a cellular data network, or any combination thereof. The mobile device 118 may then store the credential 126 in a secure element 128.

To gain access to a conference room, the mobile device 118 may transmit the credential 126 to a reader device 130, such as a reader and/or a lock, that secures the conference room. The mobile device 118 and the reader device 130 may communicate using Near Field Communication (NFC) and/or any other protocol(s). The reader device 130 may be an offline reader and/or lock. However, it is contemplated that the reader device 130 may be an online reader and/or lock. Furthermore, it is contemplated that the credential server 124 and/or access control system 111 may deliver credential information and/or access rights information to an online reader and/or lock.

Equipment 107 may also be reserved, accessed, and used via the credential 126 on the mobile device 118 of the participant 116. Equipment 107 may include projectors, laptops, and/or other devices that may be kept in lockers electronically controlled. In addition, the equipment 107 may also include any type of credential-controlled equipment such as an electric vehicle (e.g., a golf cart used on a large campus) or a refrigerator in the meeting room 105. Equipment 132 may communicate with the mobile device 118 using any communication protocol such as NFC or Bluetooth.

Other features and/or variations of the present application may include one or more of the following. For example, a mobile credential already exists in the secure element 128 of the mobile device 118 to open a participant's own office and therefore an extension for a credential may be sent to the mobile device 118 rather than a new or a different credential. The extension of the credential may include information that indicates to the lock that the mobile device 118 has authority access the room. One example may include a coded data format based on TLV.

In other embodiments, a credential already on the mobile device 118 is not updated, but the access control system 111 is updated to allow the mobile device 118 access to the room 105 during the day and time allocated for the meeting. In these embodiments, typically, the reader device 130 grants access after the access control system 111 approves that the credential 126 from the mobile device 118 is allowed to access the room 105.

In another example, a participant 116 may receive the credential 126 for a colleague that is still using a plastic card credential. The participant 116 may then transfer the credential 126 to the plastic card credential using the mobile device 118.

In yet another example, the booking time window for a resource may be limited. As another example, a meeting organizer 102 may receive a response message that includes information about the delivery of the credentials 126 including who has access to the room 105 and/or equipment 107. In another example, management of recurring meetings may be handled in various ways such as sending new credentials before each meeting, sending one credential that will work for all meetings, or a combination thereof.

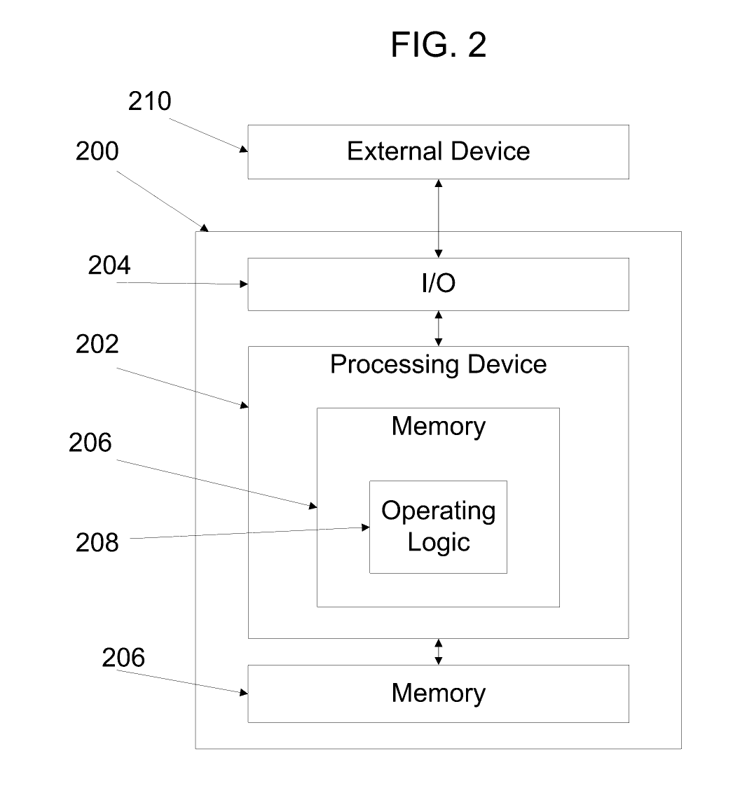

FIG. 2 is a schematic block diagram of a computing device 200. The computing device 200 is one example of a computer, server, mobile device, reader device, or equipment configuration which may be utilized in connection with the computer 106, server 110, mobile device 118, server 124, reader device 130, or equipment 107 shown in FIG. 1. Computing device 200 includes a processing device 202, an input/output device 204, memory 206, and operating logic 208. Furthermore, computing device 200 communicates with one or more external devices 210.

The input/output device 204 allows the computing device 200 to communicate with the external device 210. For example, the input/output device 204 may be a network adapter, network card, interface, or a port (e.g., a USB port, serial port, parallel port, an analog port, a digital port, VGA, DVI, HDMI, FireWire, CAT 5, or any other type of port or interface). The input/output device 204 may be comprised of hardware, software, and/or firmware. It is contemplated that the input/output device 204 includes more than one of these adapters, cards, or ports.

The external device 210 may be any type of device that allows data to be inputted or outputted from the computing device 200. For example, the external device 210 may be a mobile device, a reader device, equipment, a handheld computer, a diagnostic tool, a controller, a computer, a server, a printer, a display, an alarm, an illuminated indicator such as a status indicator, a keyboard, a mouse, or a touch screen display. Furthermore, it is contemplated that the external device 210 may be integrated into the computing device 200. It is further contemplated that there may be more than one external device in communication with the computing device 200.

Processing device 202 can be of a programmable type, a dedicated, hardwired state machine, or a combination of these; and can further include multiple processors, Arithmetic-Logic Units (ALUs), Central Processing Units (CPUs), Digital Signal Processors (DSPs) or the like. For forms of processing device 202 with multiple processing units, distributed, pipelined, and/or parallel processing can be utilized as appropriate. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a combination of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

The processes in the present application may be implemented in operating logic 208 as operations by software, hardware, artificial intelligence, fuzzy logic, or any combination thereof, or at least partially performed by a user or operator. In certain embodiments, modules represent software elements as a computer program encoded on a computer readable medium, wherein the computer 106, server 110, mobile device 118, server 124, equipment 107, and/or reader device 130 performs the described operations when executing the computer program.

The present application may include one or more of the following features. For example, the present application may include relatively simplified management compared to a mechanical credential (e.g., traditional key) because a mechanical key manager is not required and employees do not have to spend work time to obtain a mechanical key. In addition, the present application may provide better security because the present application generally reduces or eliminates the risk of an employee losing a key or not returning a key.

The present application may include one or more of the following features as compared to a plastic credential. For example, credentials are generally delivered and refreshed to a hotspot (e.g., data on card), which might not be installed inside a facility, but the present application and its delivery method may reduce this issue. As another example, an individual generally walks to certain types of doors or locks to update the door or lock's access control or rights database (e.g., data on lock), but with the present application an individual may not have to walk to a door or lock to update it.

Furthermore, the present application may allow meetings to be organized in a relatively more time efficient manner and may allow only invited individuals to enter the meeting room. Other individuals may join at a later time, which may avoid meeting interruptions by unwanted intrusions. In other embodiments, the credential may allow the person to enter a room or building that they typically do not have access to, not necessarily for a meeting, such as on school or business campuses.

It is also contemplated that the system 100 may be used to reserve and use resources, such as equipment 107, with or without reserving a meeting room. The credential 126 on the mobile device 118 would be used to access and/or control the resource.

One aspect of the present application may include a method, comprising: receiving a meeting request; transmitting a meeting invitation to one or more participants; receiving one or more acceptances from the one or more participants; transmitting a credential request to a server; and transmitting a credential to a mobile device of at least one participant.

Other features of the aspect of the present application may include one or more of the following: wherein the credential request includes an identification of at least one participant and an identification of a room; wherein the credential is valid only for a duration of the meeting; wherein the device is a mobile phone; storing the credential in a secure element of the mobile device; receiving, with a reading device, the credential from the mobile device; and/or wherein the meeting request includes a date, a time, participant list, and room for a meeting.

While the invention has been described in connection with what is presently considered to be the preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. A method, comprising:
receiving, with an email and calendar server, a meeting request for a meeting from a meeting organizer;
transmitting, with the email and calendar server, a meeting invitation to a participant in response to the meeting request;
receiving, with the email and calendar server, an acceptance from the participant based on the meeting invitation;
transmitting, with the email and calendar server, a credential request to a credential server in response to the acceptance, wherein the credential request includes an identification of the participant and an identification of a meeting room; and
transmitting, with the credential server, a credential to a mobile device of the participant, wherein the participant cannot access the meeting room without the credential and the credential provides access to the meeting room to the participant only when the participant arrives at the meeting room during a time associated with the meeting.

2. The method of claim 1, further comprising:
transmitting a response message to a meeting organizer, wherein the response message includes information about delivery of the credential to the participant.

3. The method of claim 1, wherein the credential is valid only for a duration of the meeting.

4. The method of claim 1, wherein the credential is stored in a secure element of the mobile device.

5. The method of claim 4, wherein the credential is an extension of other credential information in the secure element of the mobile device.

6. The method of claim 1, further comprising:
receiving, with a reader device associated with a lock of the meeting room, the credential from the mobile device; and
allowing access to the meeting room based on receiving the credential by unlocking the lock of the meeting room in response to the participant arriving at the meeting room.

7. The method of claim 1, wherein the meeting request includes a date, the time, a participant list, and the meeting room for the meeting.

8. The method of claim 1, further comprising:
allowing the participant to access control equipment in electronically controller lockers in the meeting room based on the credential.

9. The method of claim 1, further comprising:
transferring the credential from the mobile device to a plastic card credential.

10. The method of claim 1, further comprising:
automatically accepting, with the email and calendar server, the meeting request subject to availability of the meeting room.

11. The method of claim 1, further comprising:
transmitting a reservation request based on the meeting request to a delegate; and
receiving, with the email and calendar server, an approval or denial of the reservation request from the delegate.

12. The method of claim 1, wherein the meeting request includes a series of meetings and wherein the credential is valid for each meeting in the series.

13. A system, comprising:
a computer configured with non-transitory computer executable instructions to generate a request to reserve a resource secured with one or more electronically controlled access systems, wherein the request includes a date and a time;
one or more servers configured with non-transitory computer executable instructions to receive the request, determine if the resource is available, and transmit a credential to a user if the resource is available; and
a mobile device associated with the user in communication with the one or more servers, wherein the mobile device is configured with non-transitory computer executable instructions to receive the credential from the one or more servers, store the credential, and transmit the credential from the mobile device to provide the user access to the resource through the electronically controlled access system to utilize the resource only at the date and the time, wherein the resource includes at least one of a meeting room and equipment in the meeting room.

14. The system of claim 13, wherein the access control system includes a lock with a reader device that reads the credential when the user approaches the lock and the mobile device is further configured to communicate with the reader device via Bluetooth.

15. The system of claim 13, wherein the mobile device is further configured to store the credential in a secure element of the mobile device.

16. The system of claim 13, wherein the one or more servers are further configured to automatically accept the request subject to availability of the resource.

17. A method, comprising:
receiving a meeting request from a computer of a meeting organizer, wherein the meeting request identifies a meeting room secured with at least one electronically controlled access system;
transmitting a meeting invitation to a participant in response to the meeting request;
receiving an acceptance from the participant based on the meeting invitation;
transmitting a credential to a mobile device of the participant in response to the acceptance of the meeting invitation; and
accessing the electronically controlled access system with the credential from the mobile device when the participant arrives at the meeting room.

18. The method of claim 17, wherein the access control system includes a lock with a reader device that reads the credential when the user approaches the lock and further comprising:
allowing the participant to communicate with the reader device based on the credential via Bluetooth to unlock the lock of the meeting room only at the date and the time of the meeting request.

19. The method of claim 17, further comprising:
automatically accepting the meeting request subject to availability of the meeting room.

20. The method of claim 17, further comprising:
transmitting a reservation request based on the meeting request to a delegate; and
receiving an approval or denial of the reservation request from the delegate.
